(19) United States
(12) Patent Application Publication
(10) Pub. No.: US 2018/0373992 A1
(43) Pub. Date: Dec. 27, 2018

(54) SYSTEM AND METHODS FOR OBJECT FILTERING AND UNIFORM REPRESENTATION FOR AUTONOMOUS SYSTEMS

(71) Applicant: Futurewei Technologies, Inc., Plano, TX (US)

(72) Inventors: Xiaotian Yin, Belmont, MA (US); Lifeng Liu, Sudbury, MA (US); Yingxuan Zhu, Cambridge, MA (US); Jun Zhang, Cambridge, MA (US); Jian Li, Austin, TX (US)

(21) Appl. No.: 15/633,470

(22) Filed: Jun. 26, 2017

(51) Int. Cl. G06N 5/04; G06K 9/00; G06N 3/02

(52) U.S. Cl. CPC G06N 5/04; G06N 3/02; G06K 9/00791

(57) ABSTRACT

A computer-implemented method of controlling an autonomous system comprises: accessing, by one or more processors, sensor data that includes information regarding an area; disregarding, by the one or more processors, a portion of the sensor data that corresponds to objects outside of a region of interest; identifying, by the one or more processors, a plurality of objects from the sensor data; assigning, by the one or more processors, a priority to each of the plurality of objects; based on the priorities of the objects, selecting, by the one or more processors, a subset of the plurality of objects; generating, by the one or more processors, a representation of the selected objects; providing, by the one or more processors, the representation to a machine learning system as an input; and based on an output from the machine learning system resulting from the input, controlling the autonomous system.

### TECHNICAL FIELD

The present disclosure is related to decision making in autonomous systems and, in one particular embodiment, to systems and methods for object filtering and uniform representation for autonomous systems.

### BACKGROUND

Autonomous systems use programmed expert systems to provide reactions to encountered situations. The encountered situations may be represented by variable representations. For example, a list of objects detected by visual sensors may vary in length depending on the number of objects detected.

### SUMMARY

Various examples are now described to introduce a selection of concepts in a simplified form that are further described below in the Detailed Description. The Summary is not intended to identify key or essential features of the claimed subject matter, nor is it intended to be used to limit the scope of the claimed subject matter.

According to one aspect of the present disclosure, a computer-implemented method of controlling an autonomous system is provided that comprises: accessing, by one or more processors, sensor data that includes information regarding an area; disregarding, by the one or more processors, a portion of the sensor data that corresponds to objects outside of a region of interest; identifying, by the one or more processors, a plurality of objects from the sensor data; assigning, by the one or more processors, a priority to each of the plurality of objects; based on the priorities of the objects, selecting, by the one or more processors, a subset of the plurality of objects; generating, by the one or more processors, a representation of the selected objects; providing, by the one or more processors, the representation to a machine learning system as an input; and based on an output from the machine learning system resulting from the input, controlling the autonomous system.

Optionally, in any of the preceding aspects, the region of interest is defined by a sector map comprising a plurality of sectors, each sector of the sector map being defined by an angle range and a distance from the autonomous system.

Optionally, in any of the preceding aspects, at least two sectors of the plurality of sectors being defined by different distances from the autonomous system.

Optionally, in any of the preceding aspects, the region of interest includes a segment for each of one or more lanes.

Optionally, in any of the preceding aspects, the disregarding of the sensor data generated by the objects outside of the region of interest comprises: identifying a plurality of objects from the sensor data; for each of the plurality of objects: identifying a lane based on sensor data generated from the object; and associating the identified lane with the object; and disregarding sensor data generated by objects associated with a predetermined lane.

Optionally, in any of the preceding aspects, the method further comprises: based on the sensor data and a set of criteria, switching the region of interest from a first region of interest to a second region of interest, the first region of interest being defined by a sector map comprising a plurality of sectors, each sector of the sector map being defined by an angle range and a distance from the autonomous system, the second region of interest including a segment for each of one or more lanes.

Optionally, in any of the preceding aspects, the method further comprises: based on the sensor data and a set of criteria, switching the region of interest from a first region of interest to a second region of interest, the first region of interest including a segment for each of one or more lanes, the second region of interest being defined by a sector map comprising a plurality of sectors, each sector of the sector map being defined by an angle range and a distance from the autonomous system.

Optionally, in any of the preceding aspects, a definition of the region of interest includes a height.

Optionally, in any of the preceding aspects, the selecting of the subset of the plurality of objects comprises selecting a predetermined number of the plurality of objects.

Optionally, in any of the preceding aspects, the selecting of the subset of the plurality of objects comprises selecting the subset of the plurality of objects having priorities above a predetermined threshold.

Optionally, in any of the preceding aspects, the representation is a uniform representation that matches a representation used to train the machine learning system; and the uniform representation is a two-dimensional image.

Optionally, in any of the preceding aspects, the generating of the two-dimensional image comprises encoding a plurality of attributes of each selected object into each of a plurality of channels of the two-dimensional image.

Optionally, in any of the preceding aspects, the generating of the two-dimensional image comprises: generating a first two-dimensional image; and generating the two-dimensional image from the first two-dimensional image using a topology-preserving downsampling.

Optionally, in any of the preceding aspects, the representation is a uniform representation that matches a representation used to train the machine learning system; and the uniform representation is a vector of fixed length.

Optionally, in any of the preceding aspects, the generating of the vector of fixed length comprises adding one or more phantom objects to the vector, each phantom object being semantically meaningful.

Optionally, in any of the preceding aspects, each phantom object has a speed attribute that matches a speed of the autonomous system.

According to one aspect of the present disclosure, an autonomous system controller is provided that comprises: a memory storage comprising instructions; and one or more processors in communication with the memory storage, wherein the one or more processors execute the instructions to perform: accessing sensor data that includes information regarding an area; disregarding a portion of the sensor data that corresponds to objects outside of a region of interest; identifying a plurality of objects from the sensor data; assigning a priority to each of the plurality of objects; based on the priorities of the objects, selecting a subset of the plurality of objects; generating a representation of the selected objects; providing the representation to a machine learning system as an input; and based on an output from the machine learning system resulting from the input, controlling the autonomous system.

Optionally, in any of the preceding aspects, the region of interest is defined by a sector map comprising a plurality of sectors, each sector of the sector map being defined by an angle range and a distance from the autonomous system.

Optionally, in any of the preceding aspects, at least two sectors of the plurality of sectors are defined by different distances from the autonomous system.

According to one aspect of the present disclosure, a non-transitory computer-readable medium is provided that stores computer instructions for controlling an autonomous system, that when executed by one or more processors, cause the one or more processors to perform steps of: accessing sensor data that includes information regarding an area; disregarding a portion of the sensor data that corresponds to objects outside of a region of interest; identifying a plurality of objects from the sensor data; assigning a priority to each of the plurality of objects; based on the priorities of the objects, selecting a subset of the plurality of objects; generating a representation of the selected objects; providing the representation to a machine learning system as an input; and based on an output from the machine learning system resulting from the input, controlling the autonomous system.

Any one of the foregoing examples may be combined with any one or more of the other foregoing examples to create a new embodiment within the scope of the present disclosure.

### BRIEF DESCRIPTION OF THE DRAWINGS

FIG. 1 is a data flow illustration of an autonomous system, according to some example embodiments.

FIG. 2 is a block diagram illustration of objects near an autonomous system, according to some example embodiments.

FIG. 3 is a block diagram illustration of fixed-size images representing objects near an autonomous system, according to some example embodiments.

FIG. 4 is a block diagram illustration of a fixed-size image representing objects near an autonomous system, according to some example embodiments.

FIG. 5 is a block diagram illustration of a fixed-size image representing objects near an autonomous system overlaid with a region of interest, according to some example embodiments.

FIG. 6 is a block diagram illustration of a fixed-size image representing objects near an autonomous system overlaid with a region of interest defined using sectors, according to some example embodiments.

FIG. 7 is a block diagram illustration of a fixed-size image representing objects near an autonomous system overlaid with a region of interest defined using lanes, according to some example embodiments.

FIG. 8 is a block diagram illustrating circuitry for clients and servers that implement algorithms and perform methods, according to some example embodiments.

FIG. 9 is a flowchart illustration of a method of a mechanism for controlling an autonomous system using object filtering and uniform representation, according to some example embodiments.

FIG. 10 is a flowchart illustration of a method of a mechanism for controlling an autonomous system using object filtering and uniform representation, according to some example embodiments.

FIG. 11 is a flowchart illustration of a method of a mechanism for controlling an autonomous system using object filtering and uniform representation, according to some example embodiments.

### DETAILED DESCRIPTION

In the following description, reference is made to the accompanying drawings that form a part hereof, and in which are shown, by way of illustration, specific embodiments which may be practiced. These embodiments are described in sufficient detail to enable those skilled in the art to practice the inventive subject matter, and it is to be understood that other embodiments may be utilized and that structural, logical, and electrical changes may be made without departing from the scope of the present disclosure. The following description of example embodiments is, therefore, not to be taken in a limiting sense, and the scope of the present disclosure is defined by the appended claims.

The functions or algorithms described herein may be implemented in software, in one embodiment. The software may consist of computer-executable instructions stored on computer-readable media or a computer-readable storage device such as one or more non-transitory memories or other types of hardware-based storage devices, either local or networked. The software may be executed on a digital signal processor, application-specific integrated circuit (ASIC), programmable data plane chip, field-programmable gate array (FPGA), microprocessor, or other type of processor operating on a computer system, such as a switch, server, or other computer system, turning such a computer system into a specifically programmed machine.

Data received from sensors is processed to generate a representation suitable for use as input to a controller of an autonomous system. In existing autonomous systems, the representation provided to the controller of the autonomous system may include data representing an excessively large number of objects in the environment of the autonomous system. The excess data increases the complexity of the decision-making process without improving the quality of the decision. Accordingly, a filter that identifies relevant objects prior to generating the input for the controller of the autonomous system may improve performance of the controller, the autonomous system, or both.

A uniform data representation may be more suitable for use by a controller trained by a machine-learning algorithm, compared to prior art systems using a variable data representation. Advanced machine learning algorithms (e.g., convolutional neural networks) depend on a fixed-size input and thus prefer a uniform data representation for their input. A uniform data representation is a data representation that does not change size in response to changing sensor data. Example uniform data representations include fixed-size two-dimensional images and vectors of fixed length. By contrast, a variable data representation changes size in response to changing sensor data. Example variable data representations include variable-sized images and variable-sized vectors.

In response to receiving the uniform data representation as an input, the controller of the autonomous system directs the autonomous system. Example autonomous systems include self-driving vehicles such as cars, flying drones, and factory robots. A self-driving vehicle may be used for on-road driving, off-road driving, or both.

In some example embodiments, a framework of object filtering is used in conjunction with or instead of the framework of uniform data representation. The framework of object filtering may simplify the input to the controller of the autonomous system by filtering out objects that are expected to have a minimal impact on decisions made by the controller.

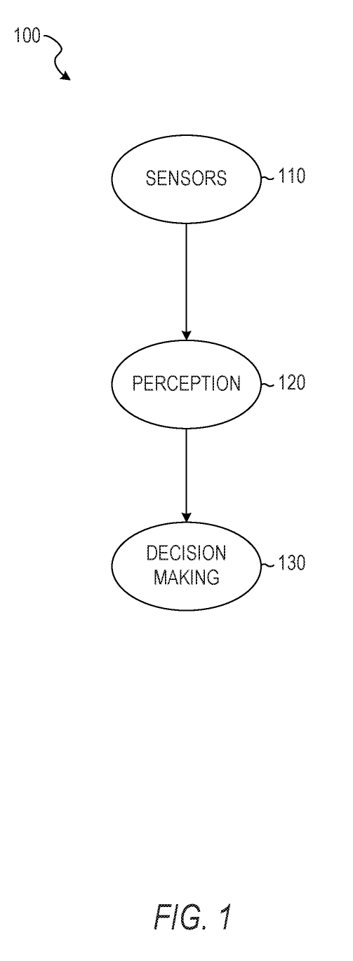

FIG. 1 is a data flow illustration 100 of an autonomous system, according to some example embodiments. The data flow illustration 100 includes sensors 110, perception 120, and decision making 130.

The sensors 110 gather raw data for the autonomous system. Example sensors include cameras, microphones, radar, vibration sensors, and radio receivers. The data gathered by the sensors 110 is processed to generate the perception 120. For example, image data from a camera may be analyzed by an object recognition system to generate a list of perceived objects, the size of each object, the relative position of each object to the autonomous system, or any suitable combination thereof. Successive frames of video data from a video camera may be analyzed to determine a velocity of each object, an acceleration of each object, or any suitable combination thereof.

The data gathered by the sensors 110 may be considered to be a function D of time t. Thus, D(t) refers to the set of raw data gathered at time t. Similarly, the perception 120 which recognizes or reconstructs a representation of the objects from which the raw data was generated, may be considered to be a function O of time t. Thus, O(t) refers to the set of environmental objects at time t.

The perception 120 is used by the decision making 130 to control the autonomous system. For example, the decision making 130 may react to perceived lane boundaries to keep an autonomous system (e.g., an autonomous vehicle) in its traffic lane. For example, painted stripes on asphalt or concrete may be recognized as lane boundaries. As another example of a reaction by the decision making 130, the decision making 130 may react to a perceived object by reducing speed to avoid a collision. The perception 120, the decision making 130, or both may be implemented using advanced machine learning algorithms.

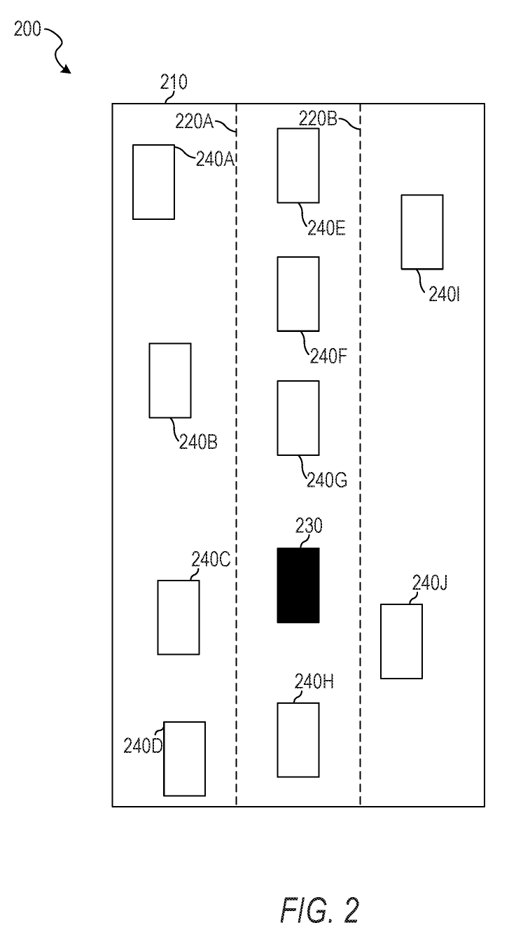

FIG. 2 is a block diagram illustration 200 of objects near an autonomous system 230, according to some example embodiments. The block diagram illustration 200 includes a region 210, lane markers 220A and 220B, the autonomous system 230, and vehicles 240A, 240B, 240C, 240D, 240E, 240F, 240G, 240H, 240I, and 240J. As can be seen in FIG. 2, a lane is a region that is logically longer in the direction of motion of the vehicle than in the perpendicular direction. The lane is not necessarily physically longer than it is wide. For example, on a tight curve, a traffic lane may bend substantially, but the lanes remain logically parallel and (overpasses, traffic intersections, and underpasses excepted) non-intersecting.

The ten vehicles 240A-240J may be perceived by the perception 120 and provided to the decision making 130 as an image, as a list of objects, or any suitable combination thereof. However, as can be seen in FIG. 2, some of the perceived vehicles 240 are unlikely to affect the results of the decision making 130. For example, the vehicles 240E and 240F are in front of the vehicle 240G, which is in front of the autonomous system 230. Thus, the autonomous system 230 must control its speed or position to avoid colliding with the vehicle 240G and will necessarily avoid colliding with the vehicles 240E and 240F as a side-effect. Accordingly, whether or not the decision making 130 is informed of the vehicles 240E and 240F, the autonomous system 230 will avoid collision with those vehicles.

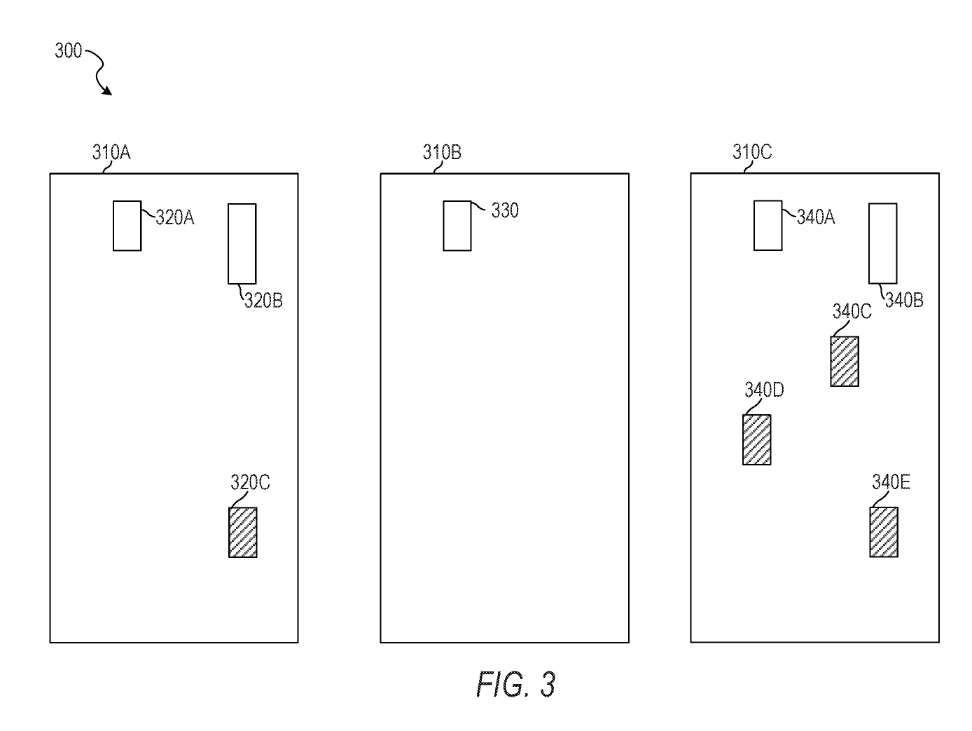

FIG. 3 is a block diagram illustration 300 of fixed-size images 310A, 310B, and 310C representing objects near an autonomous system, according to some example embodiments. The image 310A includes object depictions 320A, 320B, and 320C. The image 310B includes an object depiction 330. The image 310C includes object depictions 340A, 340B, 340C, 340D, and 340E. The fixed-size images 310A-310C (e.g., fixed-size two-dimensional images) may be provided as input from the perception 120 to the decision making 130.

Each of the fixed-size images 310A-310C use the same dimensions (e.g., 480 by 640 pixels, 1920 by 1080 pixels, or another size). Each of the fixed-size images 310A-310C includes a different number of object depictions 320A-340E. Thus, the decision making 130 can be configured to operate on fixed-size images and still be able to consider information for varying numbers of objects. The attributes of the object depictions may be considered by the decision making 130 in controlling the autonomous system. For example, the depictions 320B and 340B are larger than the other depictions of FIG. 3. As another example, the depictions 320C and 340C-340E have a different color than the objects 320A, 320B, 330, 340A, and 340B. The size of a depiction of an object in the fixed-size images 310A-310C may correspond to the size of the object represented by the depiction. The color of a depiction of an object may correspond to the speed of the object represented by the depiction, the height of the object represented by the depiction, the type of the object represented by the depiction (e.g., people, car, truck, island, sign, or any suitable combination thereof), the direction of motion of the object represented by the depiction, or any suitable combination thereof. For example, the fixed-size images 310A-310C may use the red-green-blue-alpha (RGBA) color space and indicate a different attribute of each depicted object in each of the four channels of the color space. A channel of an image is a logically-separable portion of the image that has the same dimensions as the image. A fixed-size image created to depict attributes of detected objects rather than simply conveying image data is termed a “synthetic map.”

A synthetic map may be downsampled without changing its topology. For example, a 600×800 synthetic map may be downsampled into a 30×40 synthetic map without losing the distinction between separate detected objects. In some example embodiments, downsampling allows the initial processing to be performed at a higher resolution and training of the machine learning system to be performed at a lower resolution. The use of a lower-resolution image for training a machine learning system may result in better training results than training with a higher-resolution image.

In some example embodiments, each channel (8-bit grey scale) encodes one single-valued attribute of the object. In other example embodiments, multiple attributes (e.g. binary valued attributes) are placed together into one channel, which can reduce the size of a synthetic map and therefore reduce the computational cost of the learning algorithm.

In some example embodiments, sensor generated raw images are used. However, a synthetic map may have several advantages over sensor generated raw images. For example, a synthetic map contains only the information determined to be included (e.g., a small set of most critical objects, tailored for the specific decision that the system is making) Sensor generated raw images, on the other hand, may contain a lot of information that is useless for the decision making, which is thus noise for the learning algorithm, which may overwhelm the useful information in the sensor generated raw image. In some example embodiments, training of decision making system (e.g., a convolutional neural network) will be faster or more effective using the synthetic map rather than sensor generated raw images.

Compared to sensor generated raw images, synthetic maps may allow for a larger degree of topology-preserving down-sampling (i.e., a down-sampling that maintains the distinction between represented objects). For example, a sensor generated raw image may include many objects that are close to one another, such that a down-sampling would cause multiple objects to lose their topological distinctiveness. However, a synthetic map may have more room for such down-sampling. In some example embodiments, the topology-preserving down-sampling employs per object deformation for further shrinking down, so long as there is no impact to the decision making. A performance gain due to decreased image size may exceed the performance loss due to increased image channels.

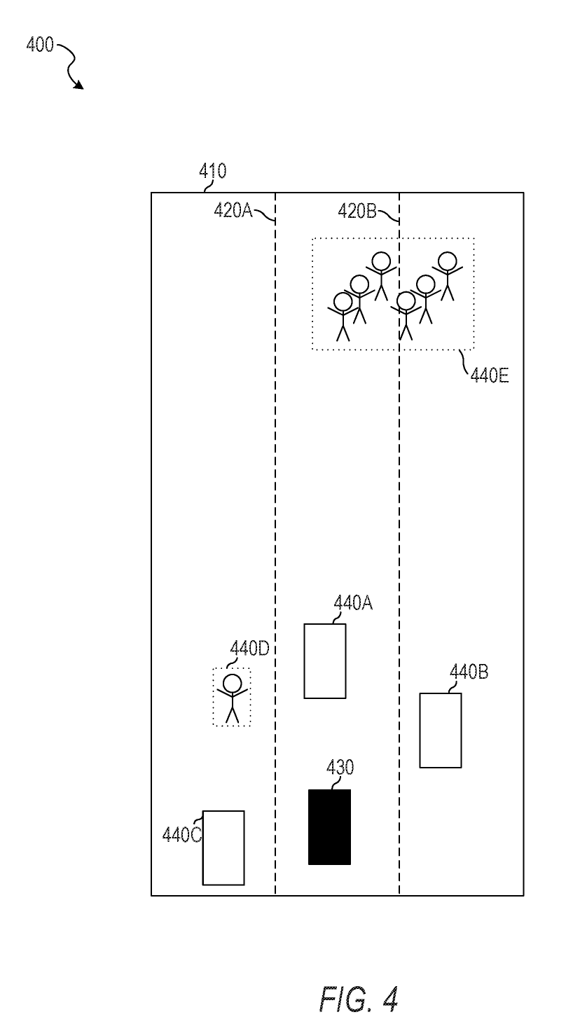

FIG. 4 is a block diagram illustration 400 of a fixed-size image 410 representing objects near an autonomous system, according to some example embodiments. The fixed-size image 410 includes lane line depictions 420A and 420B, a depiction 430 of the autonomous system, and object depictions 440A, 440B, 440C, 440D, and 440E. The object depiction 440D may be a shape generated by the perception 120 in response to detection of a person. The object depiction 440E may be a shape generated by the perception 120 in response to detection of multiple people in close proximity to each other. For example, a clustering algorithm may be used to determine when a number of detected people are treated as one object or multiple objects. In some example embodiments, the object depictions 440D and 440E are rectangular.

The fixed-size image 410 may be an image generated from raw sensor data or a synthetic image. For example, a series of images captured by a rotating camera or a set of images captured by a set of cameras mounted on the autonomous system may be stitched together and scaled to generate a fixed-size image 410. In other example embodiments, object recognition is performed on the sensor data and the fixed-size image 410 is synthetically generated to represent the recognized objects.

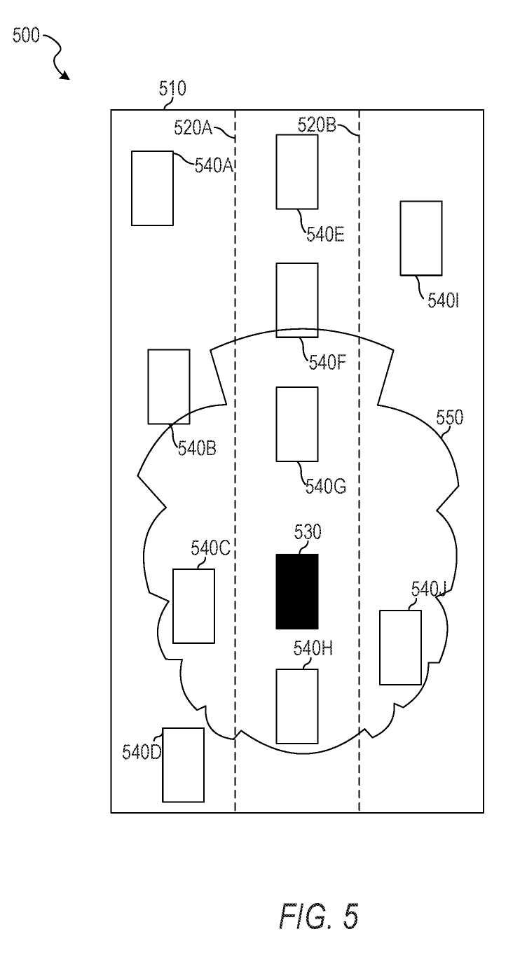

FIG. 5 is a block diagram illustration 500 of a fixed-size image 510 representing objects near an autonomous system overlaid with a region of interest 550, according to some example embodiments. The fixed size image 510 includes lane depictions 520A and 520B, a depiction 530 of the autonomous system, and object depictions 540A, 540B, 540C, 540D, 540E, 540F, 540G, 540H, 540I, and 540J. Filtering objects based on their presence within or outside of a region of interest is termed “object-oblivious filtering” because the filtering does not depend on information about the object other than location.

The region of interest 550 identifies a portion of the fixed-size image 510. The depictions 540C, 540F, 540G, 540H, and 540J are within the region of interest 550. The depictions 540A, 540D, 540E, and 540I are outside the region of interest 550. The depiction 540B is partially within the region of interest 550 and may be considered to be within the region of interest 550 or outside the region of interest 550 in different embodiments. For example, the percentage of the depiction 540B that is within the region of interest 550 may be compared to a predetermined threshold (e.g., 50%) to determine whether to treat the depiction 540B as though it were within or outside of the region of interest 550.

In some example embodiments, the perception 120 filters out the depictions that are outside of the region of interest 550. For example, the depictions 540A, 540D, 540E and 540I may be replaced with pixels having black, white, or another predetermined color value. In example embodiments in which vectors of object descriptions are used, descriptions of the objects depicted within the region of interest 550 may be provided to the decision making 130 and descriptions of the objects depicted outside the region of interest 550 may be omitted from the provided vector. In some example embodiments, sensor data corresponding to objects that are outside of the region of interest is disregarded in generating a representation of the environment.

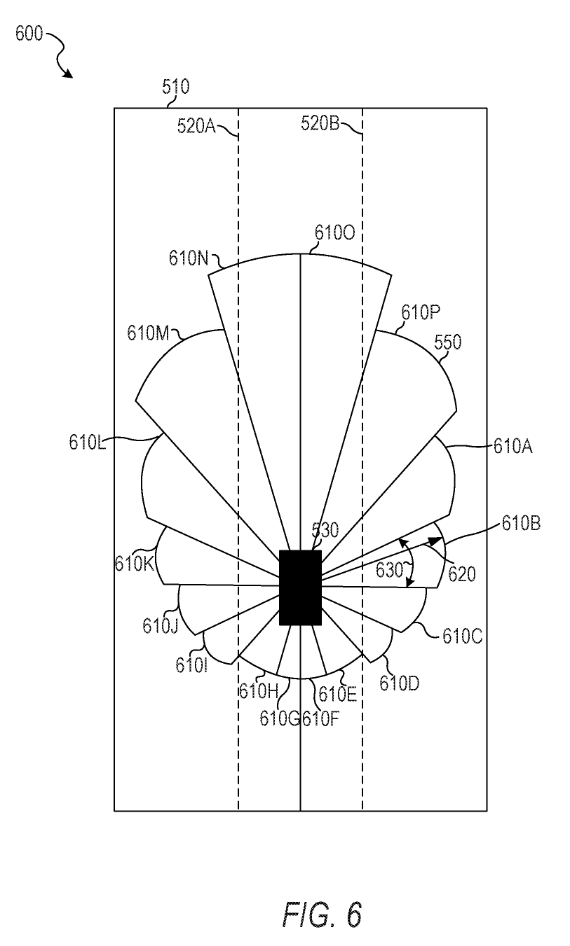

FIG. 6 is a block diagram illustration of the fixed-size image 510 representing objects near an autonomous system overlaid with the region of interest 550 defined using sectors, according to some example embodiments. The fixed-size image 510, the depictions 520A-520B of lane dividers, the depiction 530 of the autonomous system, and the region of interest 550 are discussed above with respect to FIG. 5. FIG. 6 also shows the sectors 610A, 610B, 610C, 610D, 610E, 610F, 610G, 610H, 610I, 610J, 610K, 610L, 610M, 610N, 610O, and 610P of the region of interest 550. Radius 620 and angle 630 of the sector 610B are also shown. A sector-based region of interest allows a wide range of shapes to be used for the region of interest, not only regular shapes (e.g., circle, ellipse, or rectangle).

The sector-based region of interest 550 shown in FIG. 6 may be defined by a sector map that divides the 360 degrees around the autonomous system into sectors (e.g., the sixteen sectors 610A-610P) and assigning a radius to each sector (e.g., the radius 620 of the sector 610B). Thus, each sector may be assigned a different radius. In the example of FIG. 6, the radii of the sectors 610N and 610O, in front of the autonomous system, are larger than the radii of the sectors 610G and 610F, behind the autonomous system. Additionally, the angle spanned by each sector may vary. For example, the angle 630 of the sector 610B may be larger than the angle spanned by the sector 610O.

A detected object may be detected as being partially within and partially outside the region of interest. In some example embodiments, an object partially within the region of interest is treated as being within the region of interest. In other example embodiments, an object partially outside the region of interest is treated as being outside the region of interest. In still other example embodiments, two regions of interest are used such that any object wholly or partially within the first region of interest (e.g., an inner region of interest) is treated as being within the region of interest but only objects wholly within the second region of interest (e.g., an outer region of interest) are additionally considered.

In some example embodiments, the sector map defines a height for each sector. For example, an autonomous drone may have a region of interest that includes five feet above or below the altitude of the drone in the direction of motion but only one foot above or below the altitude of the drone in the opposite direction. A three-dimensional region of interest may be useful for avoiding collisions by in-the-air objects such as a delivery drone (with or without a dangling object). Another example application of a three-dimensional region of interest is to allow tall vehicles to check vertical clearance (e.g., for a crossover bridge or a tunnel). A partial example region of interest including height is below.

| Angle (degree range) | Radius (m) | Height (m) |
|---|---|---|
| [0, 5) | 20 | 10 |
| [5, 10) | 18 | 9 |
| [10, 15) | 15 | 9 |
| . . . | . . . | . . . |

The region of interest may be statically or dynamically defined. For example, a static region of interest may be defined when the autonomous system is deployed and not change thereafter. A dynamic region of interest may change over time. Example factors for determining either a static or dynamic region of interest include the weight of the autonomous system, the size of the autonomous system, minimum braking distance of the autonomous system, or any suitable combination thereof. Example factors for determining a dynamic region of interest include attributes of the autonomous system (e.g., tire wear, brake wear, current position, current velocity, current acceleration, estimated future position, estimated future velocity, estimated future acceleration, past position, past velocity, past acceleration, or any suitable combination thereof). Example factors for determining a dynamic region of interest also include attributes of the environment (e.g., speed limit, traffic direction, presence/absence of a barrier between directions of traffic, visibility, road friction, or any suitable combination thereof).

An algorithm to compute a region of interest may be rule-based, machine learning-based, or any suitable combination thereof. Input to the algorithm may include one or more of the aforementioned factors. Output from the algorithm may be in the form of one or more region of interest tables.

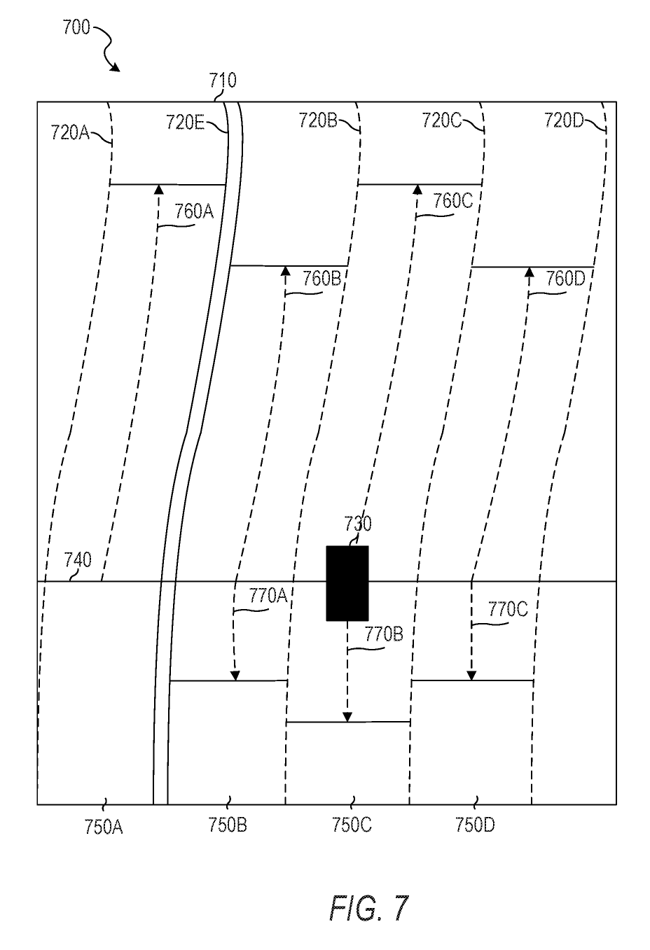

FIG. 7 is a block diagram illustration 700 of a fixed-size image 710 representing objects near an autonomous system overlaid with a region of interest defined using lanes, according to some example embodiments. The fixed-size image 710 includes lane divider depictions 720A, 720B, 720C, 720D, and 720E, and a depiction 730 of the autonomous system. FIG. 7 also shows a dividing line 740 that separates a portion of the fixed-size image 710 depicting objects forward of the autonomous system from a portion of the fixed-size image 710 depicting objects rear of the autonomous system. The lane divider depictions 720A-720E define lanes 750A, 750B, 750C, and 750D. Within each of the lanes 750A-750D, a segment is defined by a distance forward 760A, 760B, 760C, or 760D, a distance backward 770, 770B, or 770C, or both. The region of interest in the fixed-size image 710 is the combined segments within each lane 750A-750D. In contrast to the sector map of FIG. 6, in which sectors are defined by a spanned angle and a distance, the region of interest of FIG. 7 is defined by a segment (e.g., a distance forward and a distance backward) within each lane.

The lane dividers 720A-720D may represent dividers between lanes of traffic travelling in the same direction, dividers between lanes of traffic and the edge of a roadway, or both. The lane divider 720E may represent a divider between lanes of traffic travelling in opposite directions. The different representation of the lane divider depiction 720E from the lane divider depictions 720A-720D may be indicated by the use of a solid line instead of a dashed line, a colored line (e.g., yellow) instead of a black, white, or gray line, a double line instead of a single line, or any suitable combination thereof. As can be seen in FIG. 7, the lane divider depictions 720A-720E need not be parallel to the edges of the fixed-size image 710.

In some example embodiments, the region of interest is defined by a table that identifies segments for one or more lanes (e.g., identifies a corresponding forward distance and a corresponding backward distance for each of the one or more lanes). The lanes may be referred to by number. For example, the lane of the autonomous system (e.g., the lane 750C) may be lane 0, lanes to the right of lane 0 may have increasing numbers (e.g., the lane 750D may be lane 1), and lanes to the left of lane 0 may have decreasing numbers (e.g., the lane 750A may be lane −1). As another example, lanes with the same direction of traffic flow as the autonomous system may have positive numbers (e.g., the lanes 750B-750D may be lanes 1, 2, and 3) and lanes with the opposite direction of traffic flow may have negative numbers (e.g., the lane 750A may be lane −1). Some lanes may be omitted from the table or be stored with a forward distance and backward distance of zero. Any object detected in an omitted or zero-distance lane may be treated as being outside of the region of interest. An example region of interest table is below.

| Lane Identifier | Forward Distance (m) | Backward Distance (m) |
|---|---|---|
| −1 | 50 | 0 |
| 1 | 30 | 15 |
| 2 | 40 | 20 |
| 3 | 30 | 15 |

For example, a process of disregarding sensor data corresponding to objects outside of a region of interest may include identifying a plurality of objects from the sensor data (e.g., the objects 540A-540J of FIG. 5) and, for each of the plurality of objects, identifying a lane based on sensor data generated from the object, and associating the identified lane with the object. The process may continue by disregarding sensor data generated by objects associated with a predetermined lane (e.g., a lane omitted from the region of interest table).

FIG. 6 and FIG. 7 depict two ways to define a region of interest, but other definitions may also be used. For example, a region of interest could be defined as encompassing all objects within a certain radius of the autonomous system and all objects within the current lane of the autonomous system. Additionally, different regions of interest may be used by the same autonomous system in different circumstances. For example, the autonomous system may use a sector-based region of interest when the vehicle is off-road, in a parking lot, in an intersection, traveling at low speed (e.g., below 25 miles per hour), or any suitable combination thereof. In this example, the autonomous vehicle may use a lane-based region of interest when not using a sector-based region of interest (e.g., when the system is on-road, not in a parking lot, not in an intersection, traveling at high speed, or any suitable combination thereof).

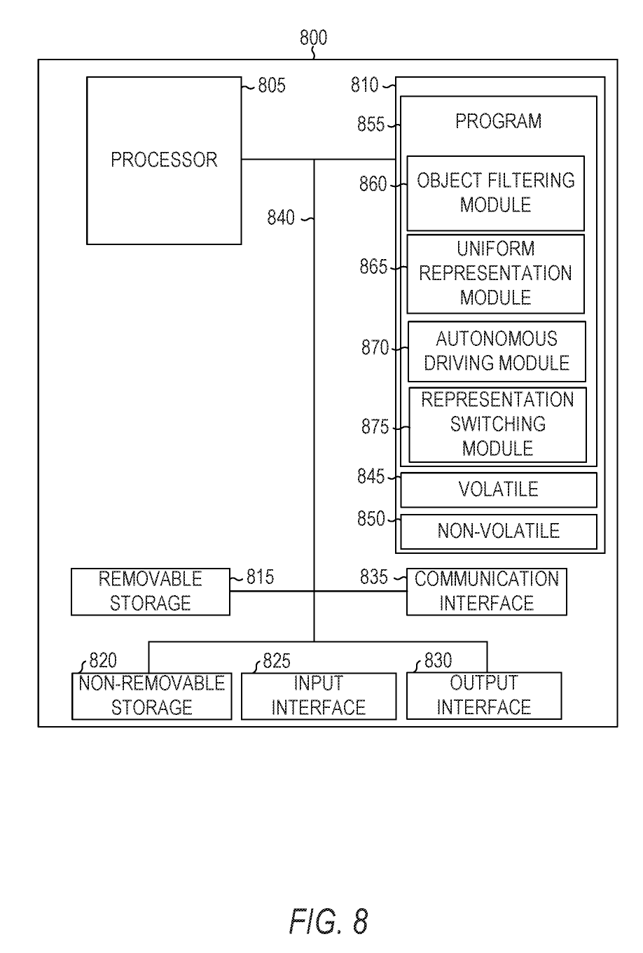

FIG. 8 is a block diagram illustrating circuitry for implementing algorithms and performing methods, according to example embodiments. All components need not be used in various embodiments. For example, clients, servers, autonomous systems, and cloud-based network resources may each use a different set of components, or, in the case of servers, for example, larger storage devices.

One example computing device in the form of a computer 800 (also referred to as computing device 800 and computer system 800) may include a processor 805, memory storage 810, removable storage 815, and non-removable storage 820, all connected by a bus 840. Although the example computing device is illustrated and described as the computer 800, the computing device may be in different forms in different embodiments. For example, the computing device 800 may instead be a smartphone, a tablet, a smartwatch, an autonomous automobile, an autonomous drone, or another computing device including elements the same as or similar to those illustrated and described with regard to FIG. 8. Devices such as smartphones, tablets, and smartwatches are generally collectively referred to as “mobile devices” or “user equipment.” Further, although the various data storage elements are illustrated as part of the computer 800, the storage may also or alternatively include cloud-based storage accessible via a network, such as the Internet, or server-based storage.

The memory storage 810 may include volatile memory 845 and non-volatile memory 850, and may store a program 855. The computer 800 may include—or have access to a computing environment that includes—a variety of computer-readable media, such as the volatile memory 845, the non-volatile memory 850, the removable storage 815, and the non-removable storage 820. Computer storage includes random-access memory (RAM), read-only memory (ROM), erasable programmable read-only memory (EPROM) and electrically erasable programmable read-only memory (EEPROM), flash memory or other memory technologies, compact disc read-only memory (CD ROM), digital versatile disks (DVD) or other optical disk storage, magnetic cassettes, magnetic tape, magnetic disk storage or other magnetic storage devices, or any other medium capable of storing computer-readable instructions.

The computer 800 may include or have access to a computing environment that includes an input interface 825, an output interface 830, and a communication interface 835. The output interface 830 may interface to or include a display device, such as a touchscreen, that also may serve as an input device 825. The input interface 825 may interface to or include one or more of a touchscreen, a touchpad, a mouse, a keyboard, a camera, one or more device-specific buttons, one or more sensors integrated within or coupled via wired or wireless data connections to the computer 800, and other input devices. The computer 800 may operate in a networked environment using the communication interface 835 to connect to one or more remote computers, such as database servers. The remote computer may include a personal computer (PC), server, router, network PC, peer device or other common network node, or the like. The communication interface 835 may connect to a local-area network (LAN), a wide-area network (WAN), a cellular network, a WiFi network, a Bluetooth network, or other networks.

Computer-readable instructions stored on a computer-readable medium (e.g., the program 855 stored in the memory storage 810) are executable by the processor 805 of the computer 800. A hard drive, CD-ROM, and RAM are some examples of articles including a non-transitory computer-readable medium such as a storage device. The terms “computer-readable medium” and “storage device” do not include carrier waves to the extent that carrier waves are deemed too transitory. “Computer-readable non-transitory media” includes all types of computer-readable media, including magnetic storage media, optical storage media, flash media, and solid-state storage media. It should be understood that software can be installed in and sold with a computer. Alternatively, the software can be obtained and loaded into the computer, including obtaining the software through a physical medium or distribution system, including, for example, from a server owned by the software creator or from a server not owned but used by the software creator. The software can be stored on a server for distribution over the Internet, for example.

The program 855 is shown as including an object filtering module 860, a uniform representation module 865, an autonomous driving module 870, and a representation switching module 875. Any one or more of the modules described herein may be implemented using hardware (e.g., a processor of a machine, an ASIC, an FPGA, or any suitable combination thereof). Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The object filtering module 860 is configured to filter out detected objects outside of a region of interest. For example, the input interface 825 may receive image or video data received from one or more cameras. The object filtering module 860 may identify one or more objects detected within the image or video data and determine if each identified object is within the region of interest.

Objects identified as being within the region of interest by the object filtering module are considered for inclusion, by the uniform representation module 865, in the data passed to the autonomous driving module 870. For example, a fixed-length list of data structures representing the objects in the region of interest may be generated by the uniform representation module 865. If the number of objects within the region of interest exceeds the size of the fixed-length list, a predetermined number of objects may be selected for inclusion in this list based on their proximity to the autonomous system, their speed, their size, their type (e.g., pedestrians may have a higher priority for collision avoidance than vehicles), or any suitable combination thereof. The predetermined number may correspond to the fixed length of the list of data structures. Filtering objects by priority is termed “object-aware filtering,” because the filtering takes into account attributes of the object beyond just the position of the object.

In some example embodiments, a table in a database stores the priority for each type of object (e.g., a bicycle, a small vehicle, a large vehicle, a pedestrian, a building, an animal, a speed bump, an emergency vehicle, a curb, a lane divider, an unknown type, or any suitable combination thereof). Each detected object is passed to an image-recognition application to identify the type of the detected object. Based on the result from the image-recognition application, a priority for the object is looked up in the database table. In example embodiments in which a predetermined number of objects are used as a uniform representation, the predetermined number of objects having the highest priority may be selected for inclusion in the uniform representation. In example embodiments in which a fixed-size image is used as a uniform representation, a predetermined number of objects having the highest priority may be represented in the fixed size image or objects having a priority above a predetermined threshold may be represented in the fixed size image.

In other example embodiments, the priority for each detected object is determined dynamically depending on one or more factors. Example factors for determining a priority of a detected object include attributes of the detected object (e.g., type, size, current position, current velocity, current acceleration, estimated future position, estimated future velocity, estimated future acceleration, past position, past velocity, past acceleration, or any suitable combination thereof). Example factors for determining the priority of the detected object also include attributes of the autonomous system (e.g., weight, size, minimum braking distance, tire wear, brake wear, current position, current velocity, current acceleration, estimated future position, estimated future velocity, estimated future acceleration, past position, past velocity, past acceleration, or any suitable combination thereof). Example factors for determining the priority of the detected object also include attributes of the environment (e.g., speed limit, traffic direction, presence/absence of a barrier between directions of traffic, visibility, road friction, or any suitable combination thereof).

In some example embodiments, the threshold priority at which objects will be represented is dynamic An algorithm to compute the threshold may be rule-based, machine learning-based, or any suitable combination thereof. Input to the algorithm may include one or more factors (e.g., attributes of detected objects, attributes of the autonomous system, attributes of the environment, or any suitable combination thereof). Output from the algorithm may be in the form of a threshold value.

The autonomous driving module 870 is configured to control the autonomous system based on the input received from the uniform representation module 865. For example, a trained neural network may control the autonomous system by altering a speed, a heading, an altitude, or any suitable combination thereof in response to the received input.

The representation switching module 875 is configured to change the uniform representation used by the uniform representation module 865 in response to changing conditions, in some example embodiments. For example, the uniform representation 865 may initially use a fixed-length vector of size three, but, based on detection of heavy traffic, be switched to use a fixed-length vector of size five by the representation switching module 875.

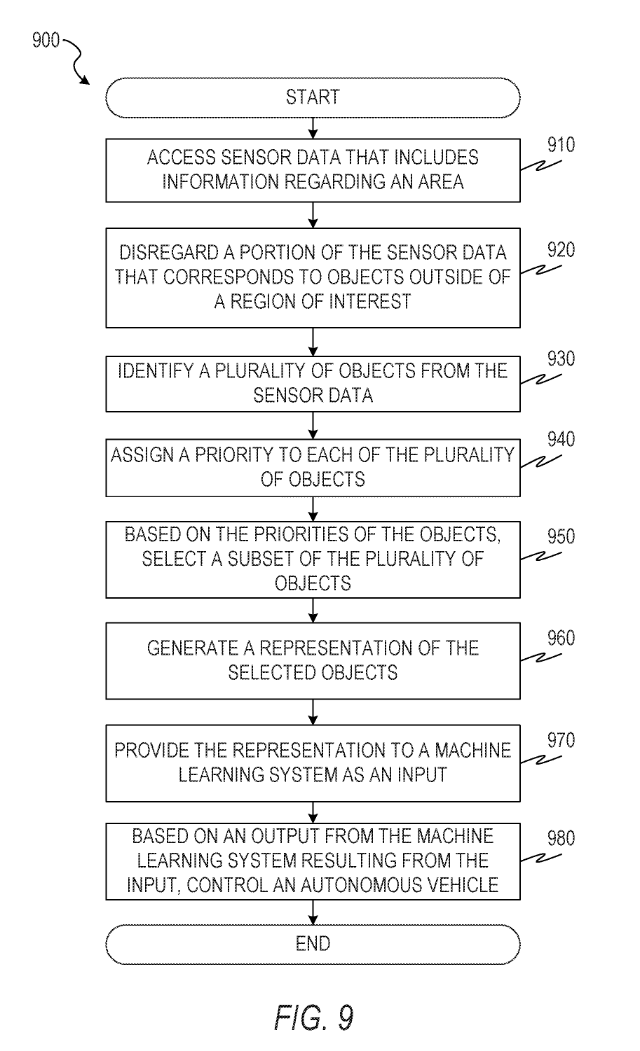

FIG. 9 is a flowchart illustration of a method 900 of a mechanism for controlling an autonomous system using object filtering and uniform representation, according to some example embodiments. The method 900 includes operations 910, 920, 930, 940, 950, 960, 970, and 980. By way of example and not limitation, the method 900 is described as being performed by elements of the computer 800, described above with respect to FIG. 8.

In operation 910, the object filtering module 860 accesses sensor data that includes information regarding an area. For example, image data, video data, audio data, radar data, lidar data, sonar data, echolocation data, radio data, or any suitable combination thereof may be accessed. The sensors may be mounted on the autonomous system, separate from the autonomous system, or any suitable combination thereof.

The sensor data may have been pre-processed to combine data from multiple sensors into a combined format using data fusion, image stitching, object detection, object recognition, object reconstruction, or any suitable combination thereof. The combined data may include three-dimensional information for detected objects, such as a three-dimensional size, a three-dimensional location, a three-dimensional velocity, a three-dimensional acceleration, or any suitable combination thereof.

In operation 920, the object filtering module 860 disregards a portion of the sensor data that corresponds to objects outside of a region of interest. For example, a rotating binocular camera may take pictures of objects around the autonomous system while simultaneously determining the distance from the autonomous system to each object as well as the angle between the direction of motion of the autonomous system and a line from the autonomous system to the object. Based on this information and a region of interest (e.g., the region of interest 550 of FIGS. 5-6), sensor data that corresponds to objects outside of the region of interest may be disregarded. For example, the portions of image data representing objects being disregarded may be replaced by a uniform neutral color.

In operation 930, the object filtering module 860 identifies a plurality of objects from the sensor data. For example, the accessed sensor data may be analyzed to identify objects and their locations relative to the autonomous system (e.g., using image recognition algorithms). In various example embodiments, operation 930 is performed before or after operation 920. For example, a first sensor may determine the distance in each direction to the nearest object. Based on the information from the first sensor indicating that an object is outside of a region of interest, the object filtering module 860 may determine to disregard information from a second sensor without identifying the object. As another example, a sensor may provide information useful for both identification of the object and determination of the location of the object. In this example, the information for the object may be disregarded due to being outside the region of interest after the object is identified.

In operation 940, the object filtering module 860 assigns a priority to each of the plurality of objects. For example, a priority of each object may be based on its proximity to the autonomous system, its speed, its size, its type (e.g., pedestrians may have a higher priority for collision avoidance than vehicles), or any suitable combination thereof.

In operation 950, the uniform representation module 865 selects a subset of the plurality of objects based on the priorities of the objects. For example, a fixed-length list of data structures representing the objects in the region of interest may be generated by the uniform representation module 865. If the number of objects within the region of interest exceeds the size of the fixed-length list, a predetermined number of objects may be selected for inclusion in this list based on their priorities. The predetermined number selected for inclusion may correspond to the fixed length of the list of data structures. For example, the k highest-priority objects may be selected, where k is the fixed length of the list of data structures.

In operation 960, the uniform representation module 865 generates a representation of the selected objects. In some example embodiments, depictions of the identified objects are placed in a fixed-size image. Alternatively or additionally, data structures representing the selected objects may be placed in a vector. For example, a vector of three objects may be defined as <o₁, o₂, o₃>.

In operation 970, the uniform representation module 865 provides the representation to a machine learning system as an input. For example, the autonomous driving module 870 may include a trained machine learning system and receive the uniform representation from the uniform representation module 865. Based on the input, the trained machine learning system generates one or more outputs that indicate actions to be taken by the autonomous system (e.g., steering actions, acceleration actions, braking actions, or any suitable combination thereof).

In operation 980, based on an output from the machine learning system resulting from the input, the autonomous driving module 870 controls the autonomous system. For example, a machine learning system that is controlling a car may generate a first output that indicates acceleration or braking and a second output that indicates how far to turn the steering wheel left or right. As another example, a machine learning system that is controlling a weaponized drone may generate an output that indicates acceleration in each of three dimensions and another output that indicates where and whether to fire a weapon.

The operations of the method 900 may be repeated periodically (e.g., every 10 ms, every 100 ms, or every second). In this manner, an autonomous system may react to changing circumstances in its area.

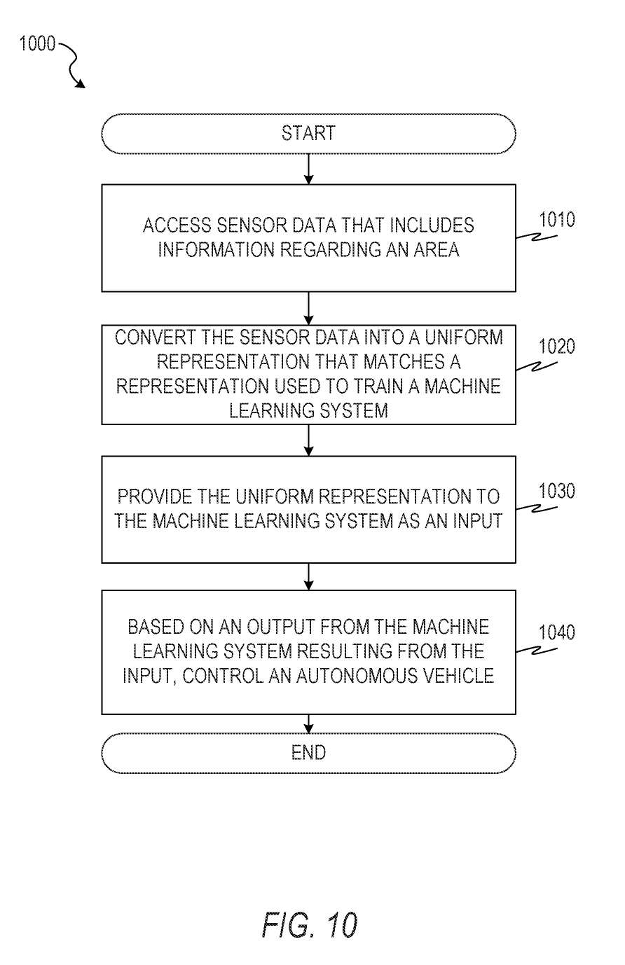

FIG. 10 is a flowchart illustration of a method 1000 of a mechanism for controlling an autonomous system using object filtering and uniform representation, according to some example embodiments. The method 1000 includes operations 1010, 1020, 1030, and 1040. By way of example and not limitation, the method 1000 is described as being performed by elements of the computer 800, described above with respect to FIG. 8.

In operation 1010, the object filtering module 860 accesses sensor data that includes information regarding an area. For example, image data, video data, audio data, radar data, lidar data, sonar data, echolocation data, radio data, or any suitable combination thereof may be accessed. The sensors may be mounted on the autonomous system, separate from the autonomous system, or any suitable combination thereof.

The sensor data may have been pre-processed to combine data from multiple sensors into a combined format using data fusion, image stitching, object detection, object recognition, object reconstruction, or any suitable combination thereof. The combined data may include three-dimensional information for detected objects, such as a three-dimensional size, a three-dimensional location, a three-dimensional velocity, a three-dimensional acceleration, or any suitable combination thereof.

In operation 1020, the uniform representation module 865 converts the sensor data into a uniform representation that matches a representation used to train a machine learning system. For example, the accessed sensor data may be analyzed to identify objects and their locations relative to the autonomous system. Depictions of the identified objects may be placed in a fixed-size image. Alternatively or additionally, data structures representing the identified objects may be placed in a fixed-size vector. When fewer objects than the fixed size of the vector are selected, placeholder objects may be included in the vector: <o₁, p, p>. In some example embodiments, the attributes of the placeholder object are selected to minimize their impact on the decision-making process. The placeholder object (also referred to as a “phantom object,” since it does not represent a real object) may be defined as an object of no size, no speed, no acceleration, at a great distance away from the autonomous system, behind the autonomous system, speed matching the speed of the autonomous system, or any suitable combination thereof. The phantom object may be selected to be semantically meaningful. That is, the phantom object may be received as an input to the machine learning system that can be processed as if it were a real object without impacting the decision generated by the machine learning system.

In some example embodiments, phantom objects are not used. Instead, objects of arbitrary value (referred to as “padding objects”) are included in the fixed size vector when too few real objects are detected. A separate indicator vector of the fixed size is provided to the learning algorithm. The indicator vector indicates which slots are valid and which are not (e.g., are to be treated as empty). However, in deep learning, for example, without an explicit conditional branching mechanism that checks the indicator first before grabbing the corresponding object slot, it is difficult to prove that the indicator vector works as expected. In other words, it is possible that the padding objects actually impact the decision making, unexpectedly. Since the padding value may be arbitrary, the generated impact may also be arbitrary. Thus, using phantom objects with attributes selected to minimize the impact on decision making may avoid problems with indicator vectors. For example, the machine learning algorithm does not need to syntactically distinguish between real objects and padded ones during training, and the resulting decision will not be impacted by the padded objects due to how they are semantically defined.

In operation 1030, the uniform representation module 865 provides the uniform representation to the machine learning system as an input. For example, the autonomous driving module 870 may include the trained machine learning system and receive the uniform representation from the uniform representation module 865. Based on the input, the trained machine learning system generates one or more outputs that indicate actions to be taken by the autonomous system.

In operation 1040, based on an output from the machine learning system resulting from the input, the autonomous driving module 870 controls the autonomous system. For example, a machine learning system that is controlling a car may generate a first output that indicates acceleration or braking and a second output that indicates how far to turn the steering wheel left or right. As another example, a machine learning system that is controlling a weaponized drone may generate an output that indicates acceleration in each of three dimensions and another output that indicates where and whether to fire a weapon.

The operations of the method 1000 may be repeated periodically (e.g., every 10 ms, every 100 ms, or every second). In this manner, an autonomous system may react to changing circumstances in its area.

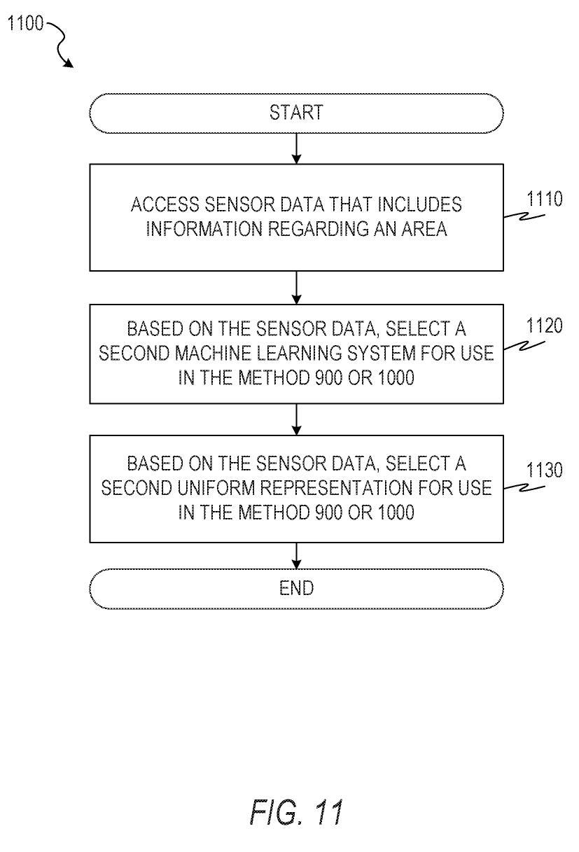

FIG. 11 is a flowchart illustration of a method 1100 of a mechanism for controlling an autonomous system using object filtering and uniform representation, according to some example embodiments. The method 1100 includes operations 1110, 1120, and 1130. By way of example and not limitation, the method 1100 is described as being performed by elements of the computer 800, described above with respect to FIG. 8.

In operation 1110, the representation switching module 875 accesses sensor data that includes information regarding an area. Operation 1110 may be performed similarly to operation 1010, described above with respect to FIG. 10.

In operation 1120, the representation switching module 875, based on the sensor data, selects a second machine learning system for use in the method 900 or the method 1000. For example, the autonomous system may include two machine learning systems for controlling the autonomous system. The first machine learning system may have been trained using a first fixed-size input (e.g., a fixed-size vector or fixed-size image). The second machine learning system may have been trained using a second, different, fixed-size input. Based on the sensor data (e.g., detection in a change of speed of the autonomous system, a change in the number of objects detected in a region of interest, or any suitable combination thereof), the representation switching module 875 may switch between the two machine learning systems.

For example, the first machine learning system may be used at low speeds (e.g., below 25 miles per hour), with few objects in a region of interest (e.g., less than 5 objects), in open areas (e.g., off-road or in parking lots), or any suitable combination thereof. Continuing with this example, the second learning system may be used at high speeds (e.g., above 50 miles per hour), with many objects in a region of interest (e.g., more than 8 objects), on roads, or any suitable combination thereof. A threshold for switching from the first machine learning system to the second learning system may be the same as a threshold for switching from the second learning system to the first machine learning system or different. For example, a low-speed machine learning system may be switched to at low speeds, a high-speed machine learning system may be switched to at high speeds, and the current machine learning system may continue to be used at moderate speeds (e.g., in the range of 25-50 MPH). In this example, driving at a speed near a speed threshold will not cause the representation switching module 875 to switch back and forth between machine learning systems in response to small variations in speed.

In operation 1130, the representation switching module 875 selects a second uniform representation for use in the method 900 or the method 1000 based on the sensor data. The selected second uniform representation corresponds to the selected second machine learning system. For example, if the selected second machine learning system uses a fixed-length vector of five objects, the second uniform representation is a fixed-length vector of five objects.

After the process 1100 completes, iterations of the method 900 or 1000 will use the selected second machine learning system and the selected uniform representation. Thus, multiple machine learning systems may be trained for specific conditions (e.g., heavy traffic or bad weather) and used only when those conditions apply.

Devices and methods disclosed herein may reduce time, processor cycles, and power consumed in controlling autonomous systems (e.g., autonomous vehicles). For example, processing power required by trained machine learning systems that use fixed-size inputs may be less than that required by systems using variable-size inputs. Devices and methods disclosed herein may also result in improved autonomous systems, resulting in improved efficiency and safety.

Although a few embodiments have been described in detail above, other modifications are possible. For example, the logic flows depicted in the figures do not require the particular order shown, or sequential order, to achieve desirable results. Other steps may be provided in, or steps may be eliminated from, the described flows, and other components may be added to, or removed from, the described systems. Other embodiments may be within the scope of the following claims.

What is claimed is:

1. A computer-implemented method of controlling an autonomous system, comprising:
accessing, by one or more processors, sensor data that includes information regarding an area;
disregarding, by the one or more processors, a portion of the sensor data that corresponds to objects outside of a region of interest included in the area;
identifying, by the one or more processors, a plurality of objects from the sensor data;
assigning, by the one or more processors, a priority to each of the plurality of objects;
based on the priorities of the objects, selecting, by the one or more processors, a subset of the plurality of objects;
generating, by the one or more processors, a representation of the selected objects;
providing, by the one or more processors, the representation to a machine learning system as an input; and
controlling the autonomous system based on an output from the machine learning system resulting from the input.

2. The computer-implemented method of claim 1, wherein:
the region of interest is defined by a sector map comprising a plurality of sectors, each sector of the sector map being defined by an angle range and a distance from the autonomous vehicle.

3. The computer-implemented method of claim 2, wherein, at least two sectors of the plurality of sectors are defined by different distances from the autonomous system.

4. The computer-implemented method of claim 1, wherein:
the region of interest includes a segment for each of one or more lanes.

5. The computer-implemented method of claim 4, wherein:
the disregarding of the sensor data generated by the objects outside of the region of interest comprises:
identifying a plurality of objects from the sensor data;
for each of the plurality of objects:
identifying a lane based on sensor data generated from the object; and
associating the identified lane with the object; and
disregarding sensor data generated by objects associated with a predetermined lane.

6. The computer-implemented method of claim 1, further comprising:
based on the sensor data and a set of criteria, switching the region of interest from a first region of interest to a second region of interest in the area, the first region of interest being defined by a sector map comprising a plurality of sectors, each sector of the sector map being defined by an angle range and a distance from the autonomous system, the second region of interest including a segment for each of one or more lanes.

7. The computer-implemented method of claim 1, further comprising:
based on the sensor data and a set of criteria, switching the region of interest from a first region of interest to a second region of interest, the first region of interest including a segment for each of one or more lanes, the second region of interest being defined by a sector map comprising a plurality of sectors, each sector of the sector map being defined by an angle range and a distance from the autonomous system.

8. The computer-implemented method of claim 1, wherein:
the region of interest includes a height.

9. The computer-implemented method of claim 1, wherein the selecting of the subset of the plurality of objects comprises selecting a predetermined number of the plurality of objects.

10. The computer-implemented method of claim 9, wherein the selecting of the subset of the plurality of objects comprises selecting the subset of the plurality of objects having priorities above a predetermined threshold.

11. The computer-implemented method of claim 1, wherein:
the generated representation is a uniform representation that matches a representation used to train the machine learning system; and
the uniform representation is a two-dimensional image

12. The computer-implemented method of claim 11, wherein:
the generating of the two-dimensional image comprises encoding a plurality of attributes of each selected object into each of a plurality of channels of the two-dimensional image.

13. The computer-implemented method of claim 11, wherein the generating of the two-dimensional image comprises:
generating a first two-dimensional image; and
generating the two-dimensional image from the first two-dimensional image using a topology-preserving downsampling.

14. The computer-implemented method of claim 1, wherein:
the representation is a uniform representation that matches a representation used to train the machine learning system; and
the uniform representation is a vector of fixed length.

15. The computer-implemented method of claim 14, wherein:
the generating of the vector of fixed length comprises adding one or more phantom objects to the vector, each phantom object being semantically meaningful.

16. The computer-implemented method of claim 15, wherein each phantom object has a speed attribute that matches a speed of the autonomous system.

17. An autonomous system controller comprising:
a memory storage comprising instructions; and
one or more processors in communication with the memory storage, wherein the one or more processors execute the instructions to perform:
accessing sensor data that includes information regarding an area;
disregarding a portion of the sensor data that corresponds to objects outside of a region of interest included in the area;
identifying a plurality of objects from the sensor data;
assigning a priority to each of the plurality of objects;
based on the priorities of the objects, selecting a subset of the plurality of objects;
generating a representation of the selected objects;
providing the representation to a machine learning system as an input; and
controlling the autonomous system based on an output from the machine learning system resulting from the input.

18. The autonomous system controller of claim 14, wherein:
the region of interest is defined by a sector map comprising a plurality of sectors, each sector of the sector map being defined by an angle range and a distance from the autonomous system.

19. The autonomous system controller of claim 18, wherein at least two sectors of the plurality of sectors are defined by different distances from the autonomous system.

20. A non-transitory computer-readable medium storing computer instructions for controlling an autonomous system, that when executed by one or more processors, cause the one or more processors to perform steps of:
accessing sensor data that includes information regarding an area;
disregarding a portion of the sensor data that corresponds to objects outside of a region of interest included in the area;
identifying a plurality of objects from the sensor data;
assigning a priority to each of the plurality of objects;
based on the priorities of the objects, selecting a subset of the plurality of objects;
generating a representation of the selected objects;
providing the representation to a machine learning system as an input; and
based on an output from the machine learning system resulting from the input, controlling the autonomous system.
